(19) United States
(12) Patent Application Publication
(10) Pub. No.: US 2015/0214609 A1
(43) Pub. Date: Jul. 30, 2015

(54) SELF-REPAIRING ANTENNAS

(71) Applicant: Carolyn M. DRY, Winona, MN (US)

(72) Inventor: Carolyn M. Dry, Winona, MN (US)

(21) Appl. No.: 14/428,624

(22) PCT Filed: Mar. 15, 2013
(86) PCT No.: PCT/US2013/032534

§ 371 Date: Mar. 16, 2015

Related U.S. Application Data
(60) Provisional application No. 61/744,035, filed on Sep. 17, 2012.
(60) Provisional application No. 61/797,231, filed on Dec. 3, 2012.
(60) Provisional application No. 61/850,261, filed on Feb. 12, 2013.

(51) Int. Cl. H01Q 1/36; H01Q 1/12

(52) U.S. Cl. CPC H01Q 1/364; H01Q 1/1271

(57) ABSTRACT

The present technology relates generally to a self-repairing antennas. Such antennas include tubes or other release vessels that comprise a self-repair agent. The antennas, tubes and self-repair agent may each be optically transparent. Furthermore, methods of making and using the self-repairing antennas are provided.

### CROSS REFERENCES TO RELATED APPLICATIONS

The present application claims priority to US provisional application No. 61/744,035, filed Sep. 17, 2012, and US provisional application entitled Integrated Antenna Transparent Platform Armor with Transparent Conductive Antenna With Transparent Conductive Self Repair Chemical, filed Nov. 11, 2012, and US provisional application entitled Integrated Antenna Transparent Platform Armor with Transparent Conductive Antenna With Transparent Conductive Self Repair Chemical, filed Feb. 11, 2013, the contents of each of which are incorporated by reference herein in their entireties.

### SUMMARY

The present technology relates to self-repairing antennas, especially optically transparent, self-repairing antennas, as well as methods of making and using such antennas. Such antennas include tubes that include a self-repair agent, such as an adhesive, e.g., epoxy, cyanoacrylate, and urethane. Both the tubes and the self-repair agent may optionally be electromagnetically conductive and thus serve as the antenna themselves or enhance the performance of the antenna. The antennas may be used in a wide variety of applications, including those where optical transparency is useful, e.g., as part of a window or certain types of composites. For examples, the present antennas may be attached or embedded into windows of cars, trucks, motorcycles and military vehicles. In addition, the antennas may also be embedded or attached to translucent or opaque composites, e.g., composites used for armor or other purposes.

### BRIEF DESCRIPTION OF THE DRAWINGS

FIGS. 1A and 1B show illustrative embodiments of the present technology in which one (FIG. 1A) or two (FIG. 1B) smaller transparent electromagnetically conductive tube(s) to be filled with a self-repair agent can fit inside a larger conductive tube to form the antenna. The ends of the inner tube(s) are sealed to contain the self-repair agent.

FIG. 2 shows an illustrative embodiment in which nested electromagnetically conductive tubes of the present technology were subjected to a force that broke the outer tube while the inner tube remained intact.

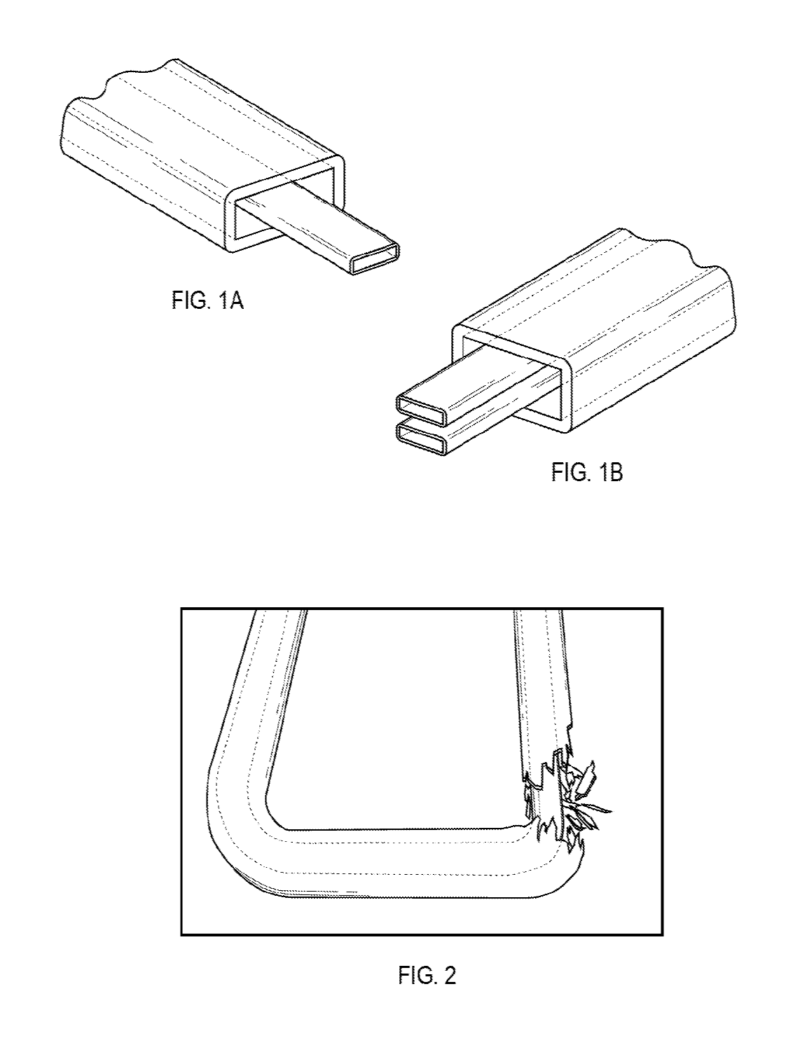

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present technology is described herein using several definitions, as set forth throughout the specification. As used herein, unless otherwise stated, the singular forms “a,” “an,” and “the” include the plural reference. Thus, for example, a reference to “a nanotube” is a reference to one or more nanotubes.

As used herein, the term “nanomaterials” refers to (non-biological) materials that have discrete structures that, in at least one dimension, are less than 1 micrometer long. Thus, individual molecules of a compound may form a nanomaterial but are not themselves a nanomaterial. For example, nanomaterials may include nanoparticles, nanotubes, nanoplates, buckyballs, nanosheets, and the like.

In one aspect, the present technology provides a self-repairing antenna. The antenna includes one or more tubes, and the tubes include a self-repair agent (also referred to as a repair chemical). In some embodiments, the antenna is optically transparent. An optically transparent object or material is one which transmits visible light and images. The tubes of the antenna may also be optically transparent and/or electromagnetically conductive. An electromagnetically conductive antenna is one that is capable of receiving and/or sending electromagnetic waves such as, e.g., radio waves and microwaves. Examples of the frequencies of such waves include 300 kHz, 1 MHz, 2 MHz, 3 MHz, 5 MHz, 10 MHz, 20 MHz, 50 MHz, 100 MHz, 200 MHz, 300 MHz, 500 MHz, 1 GHz, 2 GHz, 3 GHz, 5 GHz, 10 GHz, 20 GHz, 30 GHz, 50 GHz, 100 GHz, 200 GHz, 300 GHz, and ranges between and including any two of the foregoing values.

The antennas may take a variety of shapes and forms, including without limitation, a dipole antenna, loop antenna, conformal antenna, aperture antenna (including, e.g., shared aperture), phase array antenna, dish antenna, radar antenna, microstrip (e.g., patch) antenna, and a Yagi-Uda. Other antennas include electronically scanned antennas, multi-beam antennas, multi-band/broadband antennas, satellite-on-the-move antennas and wafer level antennas. The antennas may be integrated antennas and antenna arrays that are platform conformal. Such platforms are broadly defined and can be as diverse as the side or roof of a vehicle, the wing of an unmanned aerial vehicle (UAV) or a backpack. In some embodiments, the antennas may have broad beamwidth (>40°) or be omnidirectional. The antennas may be wideband, multiband, or single band. Antennas may also be leaky wave antennas. In some embodiments, the antenna include two or more tubes wherein at least some of the tubes are disposed within other tubes, e.g., concentrically. Such an arrangement can improve electromagnetic conductivity and/or permit different bandwidths of the electromagnetic spectrum to be accessed.

Tubes suitable for use in the present technology are hollow structures having a length that is longer than the structure's diameter or width. The tubes may have a wide variety of shapes, ranging from cylindrical to square to flattened rectangles or other polygonal shapes, including similar shapes with rounded vertices and/or curved walls. The tubes may be made of glass, polymers or composite materials. Electromagnetically conductive tubes include a material selected from conductive glass, conductive polymer, and conductive composite. In some embodiments, the electromagnetically conductive tubes include glass or polymer coated with an electromagnetically conductive film. The electromagnetically conductive film may be a transparent conducting oxide (TCO) selected from In₂O₃, SnO₂, ZnO and mixtures of any two or more thereof. In some embodiments, the conductive film includes a TCO selected from mixtures of tin and indium oxides, aluminum doped zinc oxides, tin and gallium oxides, and fluorine doped tin oxide. The TCOs may also be configured to serve as semi-conductors, such as n-type or p-type semi-conductors.

In some embodiments of the antennas, the electromagnetically conductive tubes include a conductive polymer selected from the group consisting of polyacetylene, polyaniline, polypyrrole, polythiophene, and blends or copolymers thereof. For example, the conductive polymer may be poly(3,4-ethylenedioxythiophene) doped with poly(styrenesulfonic acid).

The tubes may be larger, e.g., with outer diameters from 1 to 30 mm with a length on the order of 1-100 cm or even longer. Alternatively, the tubes may be much smaller and more fiber-like. The latter sizes are especially suitable for incorporation into self-repairing composites. As such, they may be randomly distributed in the composite or woven into an ordered structure. Some typical materials for fibers include glass, polymeric or plastic, fiberglass, quartz, carbon and metal. Other typical materials for fibers include hydrous metal oxide, silica, silicates including borosilicates, silicon, and silicate type sol-gel precursors. Examples of typical organic fibers include polyolefin fibers, polypropylene fibers, polyester fibers, polyamide fibers, polyaramid fibers, urea-formaldehyde fibers, phenolic fibers, cellulose fibers, nitrocellulose fibers, GORTEX fibers, and KEVLAR fibers. Glass fibers and similar are preferred because of the ease of melting, bending, and forming; for example, the ends can be melted to be sealed.

The tubes, whether of glass, polymer or composite, may be polarized, etched, and/or include printed information a surface of the tubes. Thus, microstrip type antennas may be etched/printed on the tubes. In some embodiments, at least some of the tubes are nested. In some instances, the outer tube is merely sacrificial and is not necessarily conductive or filled with self-repair agent although it can be.

Any of the tubes used in the present technology may be filled with a self-repair agent. Self-repair agents are compounds or groups of compounds which, when released from the self-repairing antenna herein, are capable of repairing damage to the antenna. The self-repair agent may be a liquid. Non-limiting examples of self-repair agents include adhesives (including one-part and two-part adhesives) such as an epoxy, a urethane, an epoxy vinyl ester, a vinyl ester or an acrylate, such as a cyanoacrylate. In some embodiments, the repairing agent can be modified to provide desired properties such as optical transparency, electromagnetic conductivity, heat resistance, fast chemical reaction, strength, later water proofing and longer shelf life. Additional self-repairing agents and other modifying agents or functional chemicals may be used such as any of those listed in Published U.S. Patent Applications 20120009391, 20120000810, 20110318562, 20100308276, 20070087198, and in U.S. Pat. Nos. 7,022,179, 6,261,360, 5,989,334, 5,803,963, 5,660,624, 5,575,841, and 5,561,173, the entire contents of each of which are incorporated by reference herein.

In other embodiments, the self-repair agent is a two component system. Separate tubes, each containing one of the two components, may housed together in the antenna. Upon release of both components, the two components interact (e.g., react) to form the self-repair agent. For example the two components may be an epoxy/amine system, or a polymerizable material and a catalyst. Polymerizable materials include but are not limited to monomers, oligomers, and combinations thereof. In some embodiments, the monomers include acrylates, cyanoacrylates, olefins, lactones, lactams, acrylic acids, alkyl acrylates, alkyl acrylic acids, styrenes, isoprene and butadiene. Catalysts may include known initiators, chain extenders, and the like.

Suitable cyanoacrylates include ethyl cyanoacrylate, methyl cyanoacrylate, bis 2 cyanoacrylate, cyanoacrylates with silicon, fluoroalkyl 2 cyanoacrylate, aryloxy ethyl 2 cyanoarylate, cyanoacrylates with unsaturated groups, trimethylsilyl alkyl 2 cyanoacrylate, and stabilized cyanoacrylate adhesives, such as taught in U.S. Pat. No. 6,642,337 and U.S. Pat. No. 5,530,037.

Olefins include cyclic olefins, e.g., containing 4-50 carbon atoms and optionally containing heteratoms, such as DCPD (dicyclopentadiene), substituted DCPDs, DCPD oligomers, DCPD copolymers, norbornene, substituted norbornene, cyclooctadiene, and substituted cyclooctadiene. Specific examples include, but are not limited to norbornene (such as triethoxysilylnorbornene, norbornene, ethyl norbornene, propylnorbornene, butylnorbornene, hexylnorbornene), alkyl-substituted norbornene derivatives, and alkoxysilynorbornenes. Corresponding catalysts for these are ring opening metathesis polymerization (ROMP) catalysts such as Schrock catalysts.

Lactones, such as caprolactone and lactams, when polymerized will form polyesters and nylons, respectively. Corresponding catalysts for these are cyclic ester polymerization catalysts and cyclic amide polymerization catalysts, such as scandium triflate.

In yet other embodiments, exotic reactions are used for self-repair systems. Exotic reactions include those that involve ROMP (ring-opening metathesis polymerization), Bergman cyclization, Diels Alder reaction, Schrock chemistry, DCDP (dicyclopentadiene), Grubbs ruthenium, tin and iron.

In some embodiments, the self-repair agent can withstand without degradation exposure to high temperatures, e.g., at least 250° F., e.g., at least 350° F. for 1-3 hours. Adding an amount of certain additives, at a level of at least about 1 wt % to the self-repair agent, provides improved heat resistance. Both one-part and two-part self-repair agents benefit from these additives. Examples of suitable additives include cyclic organic sulfates, sulfites, sulfoxides, sulfinates, such as esters of sulfurous acid (e.g., 2-oxo-1,3,2-dioxathiolanes), hydroquinone, and antioxidants, e.g., phenolic antioxidant, such as butylated hydroxyanisole, including butylated hydroxyanisole (BHA; tert-butyl-4-hydroxyanisole) and butylated hydroxytoluene (BHT; 2,6-di-tert-butyl-p-cresol), and those antioxidants available under the trade designation IRGANOX. Hydroquinone and 2 ethyl hexyl methacrylate inhibit boiling of the self-repair agent. In most designs, the level of the additive is between about 2-10 wt %, and in some embodiments, about 4-8 wt %.

In some embodiments, it is desired to provide the antennas with additional properties in addition to the self-repairing properties. For example, the tubes in the form of hollow glass fibers, can be filled with colored or tinted modifying agent which provides a color change upon reaction, thus providing visual indication when the modifying agent has been activated. In some embodiments, the electronic properties of the materials may be affected by the release of the modifying agent.

The self-repair agent may be electromagnetically conductive. For example, the self-repair agent may include an electromagnetically conductive additive, including but not limited to electromagnetically conductive nanotubes, particles or nanoparticles. The electromagnetically conductive particles or nanoparticles can be made of metal, glass, polymer or composite materials. Electromagnetically conductive particles or nanoparticles made of glass can be coated with a conductive film. The TCOs described herein may be used for such films. In other embodiments, the additive is a bead that includes the self-repair agent, e.g., a different self-repair agent and is optionally electromagnetically conductive. In some embodiments, the particles or nanoparticles are reflective, adding to the transparency of the tubes or antenna. In others, the particles or nanoparticles can move or be moved within a liquid self-repair agent. Thus, the frequency response of the antenna is tunable due to the changing position of the particles or nanoparticles. The tuning performance can therefore respond to various angles and polarizations of the incident electromagnetic wave, such as radio waves.

In some embodiments of the present antennas, the additives for the self-repair agent can be carbon nanotubes (CNTs). The carbon nanotubes may be single walled carbon nanotubes or multi-walled carbon nanotubes. In some embodiments the diameter of the nanotubes is less than 100 nm, such as 1 nm to 90 nm. The diameters of carbon nanotubes may be about 1 nm, about 2 nm, about 3 nm, about 4 nm, about 5 nm, about 10 nm, about 20 nm, about 30 nm, about 40 nm, about 50 nm, about 60 nm, about 70 nm, about 80 nm, about 90 nm, or a range between and including any two such values. By contrast the length of carbon nanotubes is typically far greater than the diameter, e.g., hundreds or thousands of times larger. In certain embodiments, the carbon nanotubes are interconnected at the ends of the tubes through non-covalent bonds. Such carbon nanotube networks may be in the form of a lattice or geodesic-dome-like structure.

In some embodiments, the carbon nanotubes may be coated, e.g., with one or more polymers including, but not limited to polyethylene, polypropylene, polydibenzodisilaazepine, polythiophene, poly(N-vinylcarbazole), poly(phenylene vinylene), polyaniline, poly(vinylpyridine) and polystyrene, polyethylene terephthalate as well as others listed in U.S. Pat. No. 7,357,984 (hereby incorporated by reference herein in its entirety). In still other embodiments, the surface of the carbon nanotubes may be functionalized with a variety of functional groups such as hydroxyl (—OH), amine (—NR₂, wherein each R is independently H or alkyl, alkenyl, aryl, or aralkyl), carboxylic acid (—COOH), vinyl (—CH═CH₂), aldehyde (—CHO) and/or ketone (—C(O)R wherein R is alkyl, alkenyl, aryl or aralkyl) groups.

In some embodiments of the present antennas, the additives to the self-repair agents can be particles or nanoparticles. Examples of conductive or semi-conductive particles include carbon; carbon black; graphite; silicon; silicon carbide; III-V semi-conducting materials including gallium arsenide, gallium nitride, gallium phosphide, gallium antimide, aluminum antimide, indium arsenide, indium phosphide, and indium antimide; II-VI semi-conducting materials including zinc oxide, cadmium sulfide, cadmium telluride, zinc sulfide, cadmium selenide, zinc selenide; and IV-VI semi-conducting materials including lead sulfide and lead telluride.

Metal particles or nanoparticles that may be used as additives include iron, tin, zinc, aluminum, beryllium, niobium, copper, tungsten, silver, gold, molybdenum, platinum, cobalt, nickel, manganese, cerium, silicon, titanium, tantalum, and magnesium mixtures and alloys thereof; metal alloys such as steels and tool steels, stainless steels, plain carbon steels, low carbon steels, aluminum-nickel, brass, bronze; and alloys used for biomedical applications such as cobalt-chromium, cobalt-chromium-molybdenum, cobalt-chromium-tungsten-nickel, cobalt-nickel-chromium-molybdenum-titanium, and titanium-aluminum-vanadium alloys.

Other additives include electrically active or magnetic material (e.g., beads or particles, either solid or coated) that could be used to create circulation energy, e.g., when retained in a fluid self-repair agent or other fluid. Ferrite particles or a ferrite coating could be included to absorb radar energy and produce heat. The ferrites can be positioned at various appropriate angles to the radar angle by the interaction of the charges on the individual magnetic particles. In general, the ferrites are free to move in a more active way in a liquid modifying agent, the heat from the energy conversion can be transported away via the in situ circulation system of the self-repair system, and the overall system can be multifunctional and self-repairing.

As discussed herein, the tubes in the antenna include the self-repair agent. In some embodiments, the self-repair agent is disposed in the antenna such that the antenna can retain its shape upon damage and release of the self-repair agent.

The present antennas may be configured to receive or transmit a wide variety of electromagnetic waves including, but not limited to, radio waves and microwaves. In some embodiments the tubes may conduct radio waves or microwaves. Examples of the frequencies of such waves include 300 kHz, 1 MHz, 2 MHz, 3 MHz, 5 MHz, 10 MHz, 20 MHz, 50 MHz, 100 MHz, 200 MHz, 300 MHz, 500 MHz, 1 GHz, 2 GHz, 3 GHz, 5 GHz, 10 GHz, 20 GHz, 30 GHz, 50 GHz, 100 GHz, 200 GHz, 300 GHz, and ranges between and including any two of the foregoing values.

Antennas of the present technology may be embedded or incorporated into or attached to other objects or materials such as composites. As an example of a useful composite is one that is blast-resistant and/or ballistic-resistant armor, including without limitation, self-repairing armor. Any of the antennas (and therefore tubes, self-repair agents or other components) described herein may be included in such a composite, including optically transparent ones. In some embodiments, the composite is self-repairing armor. The composites may include a self-repair agent, coating, or tube that is birefringent. The composite may be reinforced by the tubes to provide one or more of improved impact resistance, blast resistance, bending strength, flexural strength, compressive strength, and compression after impact.

Antennas of the present technology may be embedded or incorporated into or attached on to windows, including without limitation windows for houses and buildings, car, truck and motorcycle windshields, and armored windows and windshields for personnel carriers and other military vehicles. The windows may include glass or polymer, particularly optically transparent glass or polymer such as, e.g., polycarbonate. The armored windows may be a composite that includes multiple layers of polymer and electronics.

In another aspect, the present technology provides methods of making self-repairing antennas as described herein. The methods include molding or printing tubes for the antenna and filling them with any of the self-repair agents described herein.

In another aspect, the present technology provides an antenna including one or more release vessels, wherein the release vessels include a self-repair agent that can preserve or maintain the shape and/or function of the antenna after damage. The release vessel may be any of a tube, bead, or plenum.

The antennas of the present technology may further include (e.g., contain or be filled with) a functional chemical. The functional chemical may be (or function as) an antistatic agent, sensing agent, self-sensing agent, thermal conductor, electrical conductor, shape memory alloy, resistor, anti-corrosion agent, emi shielding agent, structural or mechanical filler, piezoelectric agent, armoring agent, flame retardant, or stealth agent. In some embodiments, the functional chemical is a self-repairing agent.

Still another class of functional chemicals particularly useful where the antenna and/or tubes are made out of polymers are solvents which permits solvent action to actually repair microcracking damage locally at a cracking site by, e.g., dissolving and redepositing the polymer.

### EXAMPLES

The present technology is further illustrated by the following examples, which should not be construed as limiting in any way.

### Example 1

Optically Transparent Self-Repairing Transparent Antenna

A transparent borosilicate glass tube with an outer diameter of 5 mm is coated with a transparent layer of indium oxide/tin oxide, and filled with a cyanoacrylate self-repair agent that includes ground glass particles that themselves are coated with the same TCO. The ends of the tube are heat-sealed. The latter tube is placed inside a larger diameter transparent borosilicate glass tube also coated with a transparent layer of indium oxide/tin oxide. The outer tube may be sufficiently wide to include additional self-repair agent. The resulting antenna may be tunable to more than one bandwidth, depending on the additive in the self-repair agent. The tubes may be shaped into a conformal wave guide by heating and bending the tubes.

### EQUIVALENTS

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 tubes refers to groups having 1, 2, or 3 tubes. Similarly, a group having 1-5 tubes refers to groups having 1, 2, 3, 4, or 5 tubes, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An antenna comprising one or more tubes, wherein
the tubes comprise a self-repair agent; and
the antenna is optically transparent.

2. (canceled)

3. The antenna of claim 1 wherein the tubes are optically transparent.

4. The antenna of claim 1 wherein the tubes are electromagnetically conductive and comprise a material selected from the group consisting of electromagnetically conductive glass, electromagnetically conductive polymer, and electromagnetically conductive composite.

5. The antenna of claim 4 wherein the tubes are optically transparent.

6. (canceled)

7. The antenna of claim 4 wherein the electromagnetically conductive tubes comprise a glass coated with an electromagnetically conductive film.

8. The antenna of claim 7 wherein the conductive film is a transparent conducting oxide (TCO) selected from the group consisting of In₂O₃, SnO₂, ZnO and mixtures of any two or more thereof.

9.-11. (canceled)

12. The antenna of claim 4 wherein the electromagnetically conductive tubes comprise a conductive polymer selected from the group consisting of polyacetylene, polyaniline, polypyrrole, polythiophene, and blends or copolymers thereof

13. (canceled)

14. The antenna of claim 1 wherein the tubes comprise printed information.

15.-16. (canceled)

17. The antenna of claim 1 wherein the self-repair agent is optically transparent.

18. The antenna of claim 1 wherein the self-repair agent is an adhesive.

19. The antenna of claim 18 wherein the adhesive is selected from the group consisting of epoxy, cyanoacrylate, and urethane.

20. The antenna of claim 1 wherein the self-repair agent is electromagnetically conductive.

21. The antenna of claim 20 wherein the self-repair agent comprises an electromagnetically conductive additive.

22.-27. (canceled)

28. The antenna of claim 21 wherein the additive is a bead comprising the self-repair agent.

29.-34. (canceled)

35. A composite comprising an antenna of claim 1.

36. The composite of claim 35 wherein the composite is a blast-resistant and/or ballistic-resistant armor.

37.-38. (canceled)

39. The composite of claim 35 wherein the self-repair agent, coating, or tube is birefringent.

40. (canceled)

41. A window comprising an antenna of claim 1.

42.-46. (canceled)

47. The antenna of claim 1 comprising two or more tubes wherein at least some of the tubes are disposed within other tubes.

48. The antenna of claim 47 wherein at least some of the tubes are disposed concentrically within other tubes.

49.-52. (canceled)
